(19) United States
(12) Patent Application Publication
(10) Pub. No.: US 2008/0121547 A1
(43) Pub. Date: May 29, 2008

(54) Connection System For Stackable Containers

(76) Inventors: Hansjorg Dur, Schwarzach (AT); Martin Muller, Vilemov (CZ)

Correspondence Address: NOTARO AND MICHALOS, 100 DUTCH HILL ROAD, SUITE 110, ORANGEBURG, NY, 10962-2100, US

(21) Appl. No.: 11/815,406

(22) PCT Filed: Jan. 31, 2006
(86) PCT No.: PCT/CH06/00060

§ 371 Date: Aug. 2, 2007

(30) Foreign Application Priority Data
Feb. 18, 2005 (CH) 292/05

(51) Int. Cl. B65D 21/02; F16B 2/00; B65D 21/032

(52) U.S. Cl. 206/511; 403/321

(57) ABSTRACT

The invention relates to a connection system, which enables several stackable containers 1, 2) to be interconnected for storage and transport purposes. Said system is equipped with connection elements (4), which automatically engage with one another, when the containers (1, 2) are stacked on top of one another. The connection elements (4), retaining ribs (16) and force absorption ribs (21) on the containers (1, 2) are configured in such a way that lifting forces are directly transmitted from a second container (2) to a first container (1) by means of a locking element (15) on the connection elements.

The invention relates to a connection system for stackable containers with connection elements, which automatically snap one into the other and are releasable again. These connection elements connect two containers abutting in the direction of a stacking axis, the connection elements being connected with a first container and comprising a resilient region with a latching element and on the second container holding ribs being disposed for the cooperation with these latching elements.

Stackable containers of this type utilized, for example, as material containers, tool containers or storage and/or transport containers for any goods. The individual containers as well as also the stacked containers are portable and/or transportable in other manner. The corresponding containers are most often produced of synthetic material, however, they may also be comprised of other materials, for example metal. Such stackable containers with connection elements that snap in and are releaseable again are known in several embodiments.

Stackable containers for storing and transporting goods in hospitals are disclosed in the publication DE U17244356. The containers described here comprise on two opposing side walls connection elements which automatically snap in when two containers are stacked one on top of the other and which can be released again. The connection elements provided for this purpose are U-shaped bent spring elements, which are fastened, on the one hand, on the side walls and, on the other hand, at their free end have latching lobes.

When the containers are stacked, these latching lobes engage into corresponding counterpieces on the other container which hold the latching lobe. The latching lobes include an oblique face via which during the stacking of the containers a portion of the connection element is resiliently deflected and, after the stacked position has been reached, allows the latching lobes to snap into the counterpieces. To unstack the containers, the latching lobes are manually pressed inwardly and thereby unlatched. Containers with such connection elements have the disadvantage that the connection elements must be mechanically very strong. If two or more containers are stacked and the container stack is lifted, for example via a carrying handle, and transported, the load of the lower containers is transferred via the connection elements to the carrying handles on the uppermost container. All of the connection elements and their fastenings and mountings must therefore be strong enough that they can transfer the entire weight or the corresponding forces. If the containers are filled with heavy goods and several containers are stacked one on top of the other, these forces can become very large. A further disadvantage is that the described connection elements can unintentionally become disconnected if the container stack laterally abuts hindrances or projections.

A further embodiment of stackable containers is disclosed in US A 554 47 51. The containers described here are formed of synthetic material and the connection elements are integrally injection-molded onto the upper region of the container. These connection elements extend beyond the upper edge of the container and toward the interior of the container. The connection elements include a latching lobe at the free end and, due to the elasticity of the material, can be resiliently deflected. On the bottom region of each container are openings into which the connection elements of an adjacent, or lower, container can be slid. In the proximity of the openings in the interior of the upper container are disposed holding ribs into which the latching lobes of the connection elements engage.

If containers formed thus are stacked one above the other, the connection elements of a first container automatically engage into the holding ribs of a second container. An unintentional disconnection of stacked containers through external actions is not possible in this solution. However, there is instead the disadvantage that stacked containers can only be separated from one another through the intervention into the interior volume. Here also there is the disadvantage that the entire weight of the stacked containers is transferred via the connection elements to the uppermost container with the carrying handle. This can lead to the connection elements tearing off or being damaged and therewith the containers can no longer be stacked.

The present invention addresses the problem of providing a connection system for stackable containers, in which the weight of the stacked containers, including their content, is not transferred via the connection elements to the uppermost container, in which the connection elements cannot be disconnected unintentionally through external action and in which one container of a stack, after the disconnection of the connection elements, can be lifted by means of these connection elements. The solution is, moreover, intended to permit a broad spectrum of formation solutions and optimum operating comfort and ease.

In the connection system according to the invention for stackable containers the latching elements on the connection elements include two force transfer faces, which are spaced apart from one another in the direction of the stack axis and extend approximately parallel to each other as well as approximately at right angles to the stack axis of the containers. On the first container are disposed force absorption ribs, which cooperate with a first of the force transfer faces in the form of a support face and on the second container are disposed the holding ribs, which cooperate with a second one of the force transfer faces in the form of a detent face. With the containers stacked with snapped connection elements, each of the force absorption ribs on the first container and their associated holding rib on the second container are directly connected via the latching element of a connection element. Thereby a direct chain of action for the force transfer between the containers is formed. This configuration causes that, when the containers are stacked, the weight of the lower containers and their content is not transferred across the connection elements, but rather directly via the side walls of the containers to the uppermost container with a potential carrying means. The weight of the second container is here transferred from the holding ribs fastened on the second container directly to the force absorption rib on the first container and specifically via the latching elements alone with the two force transfer faces in the form of a support face and a detent face. The holding ribs and the force absorption ribs are component parts of the side walls of the containers and are formed in suitable manner. The remaining parts of the connection elements in particular their bearing elements, are not loaded through the weight of the stacked containers, or the forces resulting therefrom. With the containers stacked with the connection elements snapped in, a direct force flow from container to container is generated via the latching elements alone.

An advantageous solution is obtained thereby that bearing elements form between the connection elements and the container a mechanical guidance without force transfer between the containers and for this force transfer only the latching element as well as the holding rib and the force transfer rib are implemented. The connection elements and the associated bearing elements can therefore be formed in a lightweight embodiment, since the forces are transferred in the direction of the stack axis only via the latching elements and the walls of the containers with the holding ribs and force transfer ribs. The simple embodiment yields savings of cost.

A further advantageous embodiment of the subject matter of the invention provides that the holding ribs on the second container are disposed on a flange of this second container, this flange overlaps a margin region of the first container when the containers are stacked and the force absorption ribs are disposed on this margin region of the first container. This disposition has the advantage that no elements of the connection elements itself project beyond the contours of a container, but rather only the flange with the holding rib which can be formed sufficiently strong. The flange can be a structural projection, a projecting lug, a mounting or another suitable physical form.

To ensure optimal and appropriate manual handling of the containers, it is useful if on the first container at least one pair of connection elements is disposed, the two connection elements of a pair being positioned on opposing side walls and on the second container corresponding pairs of holding ribs being disposed. If necessary, in particular in the case of large containers, on all side walls corresponding connection elements and holding ribs can be disposed.

According to the invention it is further proposed that between each connection element and an adjacent wall of the first container a spring element is disposed which presses the latching lobe outwardly away from the container wall. This disposition makes it possible that when stacking containers the connection elements can be deflected about the center of rotation and against the spring force from their resting positions. As soon as two adjacent containers are stacked correctly one above the other, the spring element presses the latching lobe on the connection element outwardly and therewith into the detent positions between the force absorption rib on the first container and the holding rib on the second container. This process takes place automatically and without additional manual interventions. When releasing the container connection the spring element presses the latching again into the starting position and consequently again into the ready position for the next connection. The containers can be connected such that they self-latch through simple emplacement, i.e. pressing-on or through the forces of weight of the upper container. There is no lever actuation that must be carried out for this purpose. In order to protect the connection elements against unintentional disconnections and damage, each connection elements is disposed in a recess on the outer face of a side wall of a container.

A further advantageous physical form of the invention provides that two or more containers are connected via connection elements. The system does not set any limit with respect to the number of the containers to be connected with one another in the direction of the stack axis. It is limited solely by the structural height and by the weight.

A further implementation of the invention provides that the latching element is comprised of a lobe on which the two force transfer faces are disposed. However, it can also be advantageous for the latching element to be comprised of a C-shaped clasp, on which the two force transfer faces are disposed. These solutions permit different physical forms of the system and therewith an expanded latitude for formations. Adaptations to different requirements are also possible.

A further implementation of the invention provides that the connection element is comprised of a lever and is swiveled via a bearing element in the form of a pivot on the first container, the latching element being disposed on an outer swivellable end of this lever. It has been found to be especially advantageous if the connection element is formed as a two-armed lever, where on the first lever portion the latching element is implemented and on the second lever portion a grip element. The physical form of the connection element as a two-armed lever has the advantage that the first lever portion with the latching lobe as well as the second lever portion with the grip element can be formed such, that the connection element cannot be disconnected through unintentional action from the outside. This is effected thereby that the connection elements must be pulled outwardly for the unlatching via the grip elements and about the pivot against the force of the spring element and cannot be disconnected by pressing. With the formation of the connection element as a one-armed lever the connection element is protected against unintentional disconnections thereby that each of the connection element is disposed in a recess on an outer face of a side wall of the first container. This is also the case in the two-armed embodiment, whereby in this solution the reliability is still further increased.

A practical embodiment is also obtained if the connection element is comprised of a slide, this slide being bearing supported on guides on the first container and displaceable transversely to the stack axis and the latching element is disposed on a margin region of this slide. This invented solution also expands the formation feasibilities while maintaining all other advantages. Thus, the slide can, for example, have the form of a push button.

A further advantage of the invented connection system comprises that the connection elements can either be disposed on the bottom region of a container or also in the proximity of the upper margin. One of the advantageous embodiments of the subject matter of the invention provides that the connection elements and the force absorption ribs are disposed in the bottom region of side walls of the first container and on the second container the holding ribs are formed on the upper margin. Another advantageous implementation of the subject matter of the invention, in contrast, provides that the connection elements and the force absorption ribs are disposed on the upper region of side walls of the first container and on the second container the holding ribs are formed in the bottom region of side walls. With both solutions all previously described advantages are attained. Moreover, the two solution feasibilities permit the application of the invented solution in the case of containers of the most diverse form and type. If the connection elements are disposed in the bottom region of the container, with adjacent and superjacently stacked containers the first container is the upper container and the second container the lower container. However, if the connection elements are disposed at the upper margin region of a container, then, logically, the first container is the lower container and the second container the upper container. With reference to the connection system, this designation of the container is also continued if more than two containers are stacked above one another.

It is further proposed according to the invention that with stacked containers, between each force transfer rib on the first container and the associated holding rib on the second container, in the direction of the stack axis a free interspace is formed which corresponds to the distance between the force transfer faces in the form of the support face and the detent face on the latching element in the form of a lobe. This configuration ensures the direct chain of action for the force transfer between the side walls of two abutting containers, which are disposed one above the other in the direction of the stack axis. However, it can also be advantageous if, with the containers stacked, the force transfer rib on the first container and the associated holding rib on the second container are disposed such that they are directed toward one another and in the direction of the stack axis are encompassed by the latching element in the form of a C-shaped clasp. It is further proposed according to the invention that the C-shaped clasp has an opening, this opening is limited in the direction of the stack axis by the support face and the detent face and the distance between the support face and the detent face corresponds at least to the sum of the height of the holding rib and the height of the force absorption rib. With the latching elements embodied in the form of a lobe or detent slide, this lobe, and therewith the latching element, is pressure loaded in the force chain. In the embodiment as a C-shaped clasp, it is tension loaded in the force chain. Solutions with different force flow can thereby be realized.

In the following the invention will be explained in further detail in conjunction with embodiment examples with reference to the attached drawing. Therein depict:

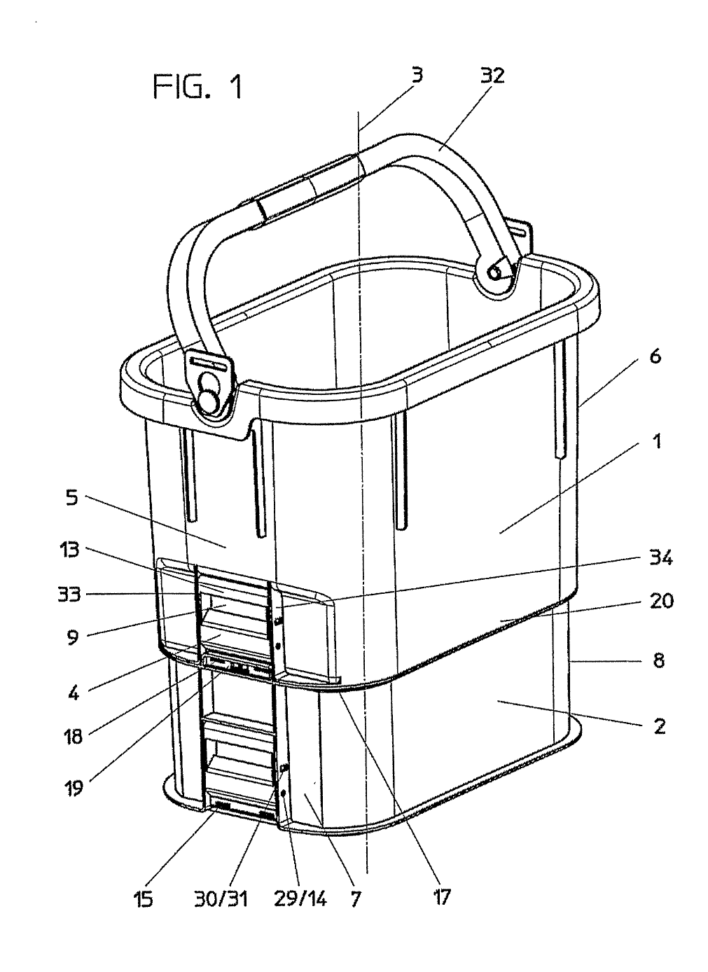

FIG. 1 two containers stacked one above the other and connected with one another with a connection system according to the invention,

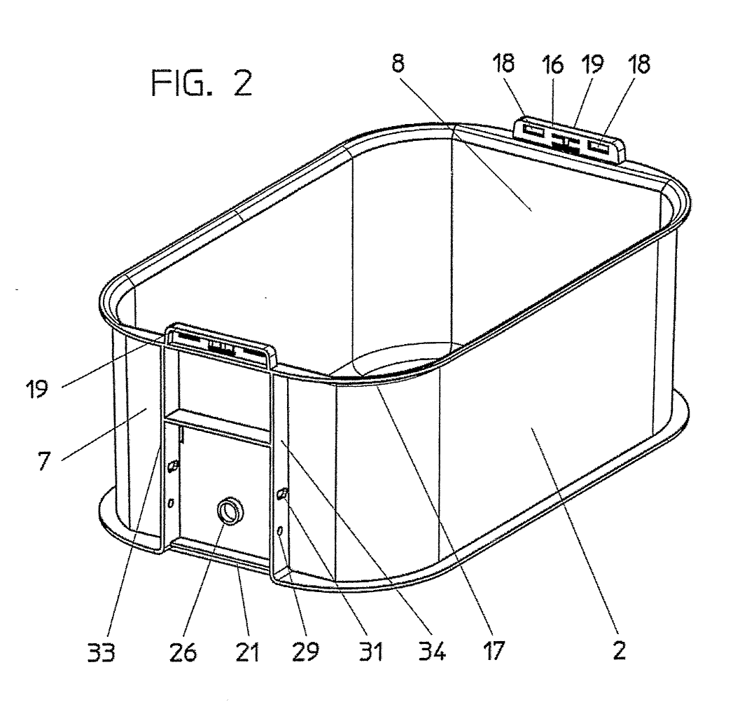

FIG. 2 a perspective view of the lower container according to FIG. 1,

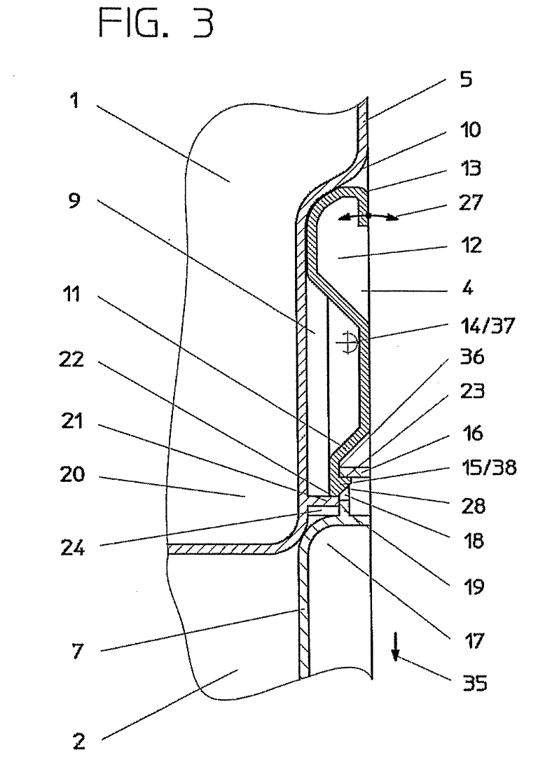

FIG. 3 a partial section through two adjacent stacked containers and a connection element with the latching lobe,

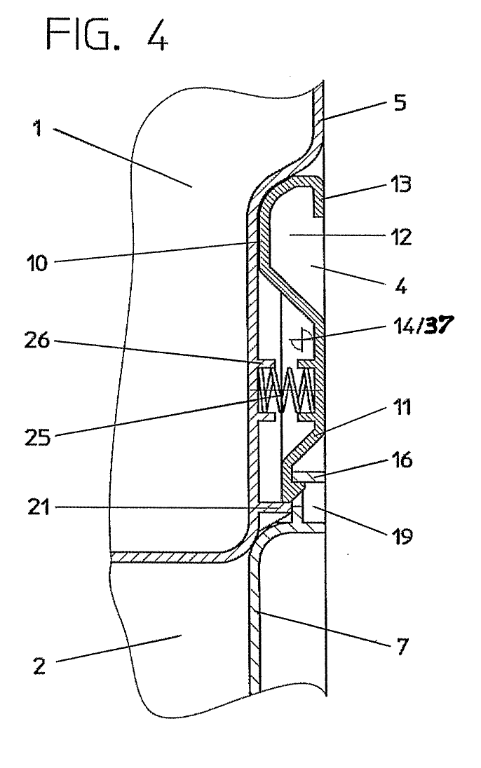

FIG. 4 a partial section through two adjacent stacked containers and a connection element with the spring,

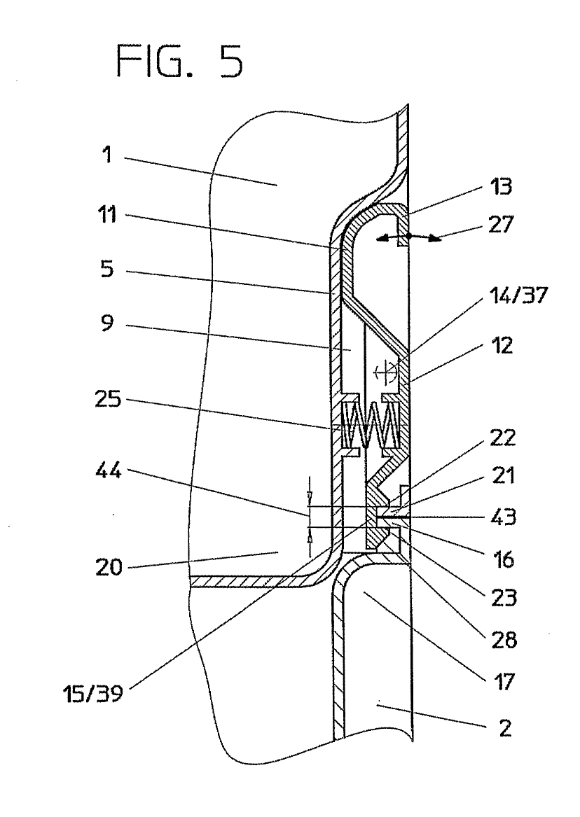

FIG. 5 a partial section through two adjacent stacked containers and a connection element with a latching element in the form of a C-shaped clasp,

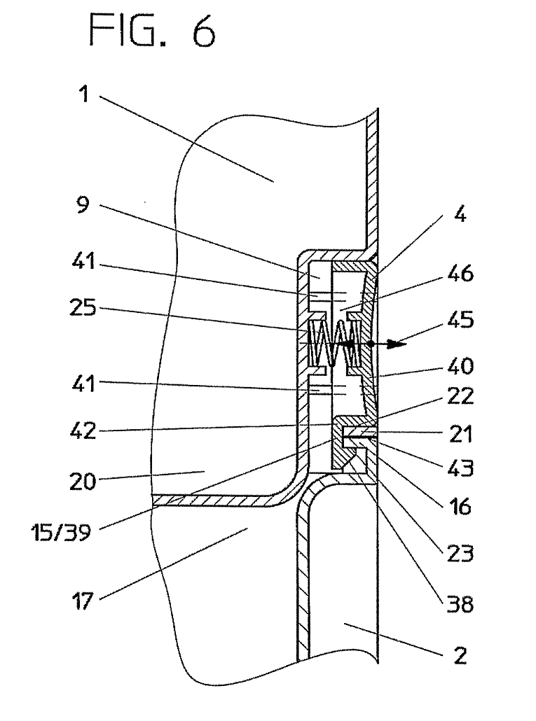

FIG. 6 a partial section through two adjacent stacked containers and a connection element in the form of a slide, and

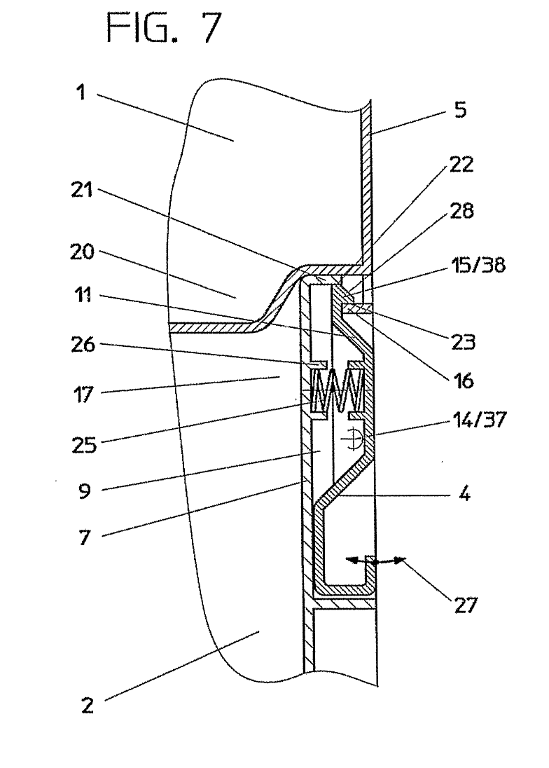

FIG. 7 a partial section through two adjacent stacked containers with the connection elements on the upper margin of the lower container.

FIG. 1 shows a perspective view of stackable containers with a connection system according to the present invention such as are used by tradespeople and mechanics, for example plumbers or electricians, or by hobbyists. A first container 1 is herein formed as a bucket with a carrying handle 32. In the bottom region 20 of two opposing side walls 5, 6 of the container 1 a pair of connection elements 4 is disposed. On both side walls 5, 6 recesses 9 are formed, which receive the connection elements 4. In addition, ribs 33, 34 are provided extending in parallel, in which bearing elements 37 and bearings 29, respectively, are formed for receiving a rotary axis 14 of the connection element 4, as well as an elongated hole 31 for the guidance of stop lobes 30 on the connection element 4. This first container 1 is stacked in the direction of the stack axis 3 above a second container 2 which, in this case represents a lower container. On opposing side walls 7, 8 at the upper margin 17 of this second container 2 is disposed one flange 19 each, which projects beyond the upper margin 17. On each of these flanges 19 is formed a holding rib 16 (see FIG. 2) and the flange 19 includes cutouts 18. On each connection element 4 of the first container 1 are provided latching elements 15 in the form of lobes 38, which engage into the cutouts 18 on flange 19 of the second container 2 and extend here beneath the holding rib 16. This can be seen in FIGS. 3 and 4. The latching elements 15 and the lobes 38 form simultaneously force transfer elements between the containers 1 and 2. In the depicted stacked position the two containers 1, 2 are connected with one another via the latching elements 15 on the snapped-in connection elements 4. To be able to form a stack with further containers, on the bottom region of the second container 2 on opposing sides 7, 8 two further connection elements 4 are disposed. Via these connection elements 4 on the second container 2 a connection with a further lower container can be established. Depending on the physical form of the containers, in this manner a multiplicity of containers, with corresponding invented connection system can be stacked one above the other and be connected with one another. Instead of a container 1, 2, it is feasible to tie into other system elements, for example a platform with rollers. For unstacking or separating the two containers 1 and 2 a grip element 13 on the connection elements 4 is manually grasped and pulled outwardly away from the side walls 5, 6. The connection elements 4 are thereby swiveled about the rotary axis 14 and the latching elements 15 are swiveled out of the holding ribs 16 on container 2. After the connection elements 4 are released, the first, or upper, container 1 can be lifted from the lower, or second, container 2 with the aid of grip elements 13 on connection elements 4. It may suffice if only one connection element 4 is released and lifted. Single-handed separation of containers 1, 2 is possible through a lateral shifting.

FIG. 2 shows a perspective view of the second, or lower, container 2 with the connection elements 4 removed. In this representation the flanges 19 disposed at the upper margin 17 of the two side surfaces 7, 8 are clearly visible. In the depicted example the flange 19 is formed by a structural projection. However, it can also be formed differently, for example as a projecting lug or mounting. The cutout 18 on flange 19 in the depicted example is interrupted by a center rib which serves as a reinforcement. The portion of flange 19 directed upwardly forms the holding rib 16. Between ribs 33 and 34 on side walls 7 or 8 is formed a holding rib 26 which serves for receiving a spring element 25 (see FIG. 4). At the bottom region of this container 2 a force absorption rib 21 is formed between the two ribs 33, 34 on the side walls 7, 8. When the containers 1, 2 are stacked one above the other, the flange 19 overlaps a margin region 24 of the first container 1, as is evident in FIG. 3.

FIG. 3 shows a cross section through a lateral region of a connection element 4 as well as a portion of the bottom region 20 of container 1 and of the upper margin region 17 of container 2. FIG. 4 shows a cross section through the same connection element 4, however, in the central region in which a spring element 25 is disposed. The connection element 4 in the depicted example is developed as a two-armed lever which is bearing supported via the rotary axis 14 as a part of the bearing element 37 and swivellable about it. The first lever portion 11 comprises at the free end the latching element 15 in the form of the lobe 38 and the second lever portion 12 is provided on the free end with a grip element 13. The connection element 4 is embedded in a recess 9 on the side wall 5 and does not project beyond the outer contour of side wall 5. In the depicted partial section the two containers 1 and 2 are stacked one above the other and connected with one another. The connection takes place via the lobes 38 on connection element 4, which engage into the cutouts 18 on flange 19 of container 2. A detent face 23 on latching element 15 or lobe 38 is herein in contact on the holding rib 16 of flange 19. A support face 22 spaced apart from the detent face 23 on latching element 15 or lobe 38, respectively, is in contact on the force absorption rib 21 of container 1. Forces acting due to the weight of container 2 in the direction of arrow 35 are thereby conducted from the holding rib 16 on side wall 7 of container 2 directly via the latching element 15, or lobe 38, to the force absorption rib 21 on side wall 5 of container 1. Lobe 38 is herein pressure loaded. In the stacked state of containers 1 and 2 the clearance distance between holding rib 16 on container 1 and force absorption rib 21 on container 1 is minimally greater than the distance between the detent face 23 and the support face 22 on latching element 15 or lobe 38. The oversize is determined such that the lobe 38 can readily be engaged and disengaged again into the interspace or the cutouts 18. Between the connection element 4 and the outer surface 10 of side wall 5 of the first container 1 is disposed the spring element 25 in the form of a curved plate spring. The spring 25 is held by the holding rib 26. The spring 25 presses the first lever portion 11 of connection element 4 away from the side wall 5 outwardly and therewith the latching element 15, or the lobe 38 in the direction of the holding rib 16. If container 1 is utilized singly, spring 25 ensures that the connection element 4 swivels completely into the recess 9 and therewith is protected.

To unlatch or unsnap the connection between the first container 1 and the second container 2 the connection elements 4 are manually grasped at the grip elements 13 and pulled outwardly in the direction of arrows 27. The first lever portion 11 of connection element 4 is thereby swiveled against the force of spring 25 in the direction of the outer surface 10 of side wall 5. Therewith the latching element 15 or the lobe 38 is swiveled out of the proximity of the holding rib 16 on container 2 and the connection is released. The first container 1 can now be lifted from the second container 2 by means of the grip elements 13. For placing the first container 1 onto the second container 2 on both containers are provided (not shown) conical faces, which cause a guided emplacement. If the first container 1 is placed onto the second container 2 or stacked above it, the oblique face 28 on latching element 15 or lobe 38 abuts the edge 36 on holding rib 16 of container 2, whereby the lobe 38 is swiveled about the rotary axis 14 with the first lever portion 11 of connection element 4. This motion occurs against the force of the spring element 25. As soon as containers 1 and 2 are completely pushed together, the latching lobe 15, as a consequence of the force action of spring 25 snaps into cutout 18 on flange 19. This process takes place automatically and does not require manual support. It is also evident in both FIGS. 3 and 4 that the connection elements 4 can only be released by manual actuation in the direction of arrows 27 and unintentional actuation through other external actions is virtually impossible.

The described embodiment example shows that the invented connection system for stackable containers ensures a secure automatic connection between two or more containers 1, 2, which can be manually released again in simple manner. The connection elements 4 and the bearing elements 37 are herein not loaded in any manner by forces or the weights of the lower containers, which act in the direction of arrows 35 and must be transferred onto the uppermost container during transporting. The corresponding chain of action of the force transfer extends directly from side walls 7, 8 of the lower container 2 via the latching lobes 15 onto side walls 5, 6 on container 1, i.e. the upper container. It is therewith ensured that the connection elements 4 and their bearing elements 37, or their rotary axis 14 and bearing 29 are not placed under load, in particular not under excessive load and are damaged. Bearing elements 37 and connection elements 4 can therefore be implemented to be relatively lightweight and according to their function and no strong embodiment is necessary in order to transfer forces.

FIG. 5 shows another embodiment of the connection element 4, where in a partial cross section the bottom region 20 of the first container 1 and the upper margin 17 of the second container 2 are shown in a simplified illustration. Connection element 4 is formed as a two-armed lever which is swivellable about a rotary axis 14 in the direction of arrows 27. The rotary axis 14 is a component part of a bearing element 37, via which the connection element 4 is connected with the first container 1. Connection element 4 is here also disposed in a recess 9 of the first container 1. On the first lever portion 11 of connection element 4 is formed the grip element 13 and on the second lever portion 12 is formed the latching element 15. Latching element 15 is comprised of a C-shaped clasp 39 on which the support face 22 and the detent face 23 are disposed. The support face 22 and the detent face 23 have in the direction of stack axis 3 the distance 44 with respect to one another and form the opening 43. In the blocked position of connection element 4 this opening 43 of the C-shaped clasp 39 encompasses the force absorption rib 21 of container 1 and the holding rib 16 of container 2. In this embodiment the latching element 15 is not pressure-loaded by rather tension-loaded, when containers 1, 2 are lifted together. Here also the force flow is conducted in a direct action chain from holding rib 16 via the latching element 15 to the force absorption rib 21. Bearing elements 37 and connection element 4 themselves are not under load and can therefore here also be implemented lightweight and practical. To reset and ensure the blocked position, between the side wall 5 of the first container 1 and the second lever portion 12 of connection element 4 is emplaced a spring element 25. Stacking and connecting the containers 1 and 2 takes place automatically in that during the joining the oblique face 28 abuts the holding rib 16 and therewith deflects the connection element 4 and is swiveled about the rotary axis 14. After reaching the final stack position, the latching element 15 snaps into the blocked position due to the reset force of spring element 25.

In FIG. 6 a further physical form of the connection element 4 is shown in simplified illustration in a partial cross section through the bottom region 20 of the first container 1 and the upper region 17 of the second container 2. The connection element 4 is comprised of a slide 40, which in the direction of arrows 45 can be pressed manually into recess 9. The resetting also takes place in the direction of arrows 45 through the spring element 25. The bearing elements 37 are here comprised of lateral guidances 41 on container 1 and corresponding lateral guide grooves 46 on slide 40. The guidances 41 and the guide grooves 46 ensure the desired movement of slide 40 in the direction of arrows 45. On a margin region 42 of slide 40 the latching element 15 in the form of a C-shaped clasp 39 is disposed. This clasp 39 encompasses the opening 43 which is delimited by support face 22 and detent face 23. Into opening 43 engage the holding rib 16 of the second container 2 and the force absorption rib 21 of the first container 1. In the blocked position of connection element 4, or of slide 40, the direct force flow is formed from the holding rib 16 via the detent face 23 and the support face 22 of the C-shaped clasp 39 to the force absorption rib 21. Slide 40 and bearing elements 37 in this embodiment are also not loaded by forces acting in the direction of stack axis 3. During the transporting or lifting of several stacked containers 1, 2 the latching elements 15, or the C-shaped clasps 39, are tension-loaded. It is also possible in simple manner to form the slide 40 with a latching element 15 in the form of a lobe 38 as shown in FIG. 3. In this case the holding rib 16 and force absorption rib 21 are also to be shaped according to the configuration according to FIG. 3 and the loading, as described in connection with FIGS. 3 and 4, would be a pressure loading.

FIG. 7 shows a partial section through a configuration in which a first container 1 and a second container 2 are stacked one above the other and the connection elements 4 are disposed at the upper margin 17 of side walls 7, 8 of container 2. In this embodiment the holding rib 16 is disposed on the bottom region 20 of container 1. Accordingly, the force absorption rib 21 is formed at the upper margin 17 of the lower container 2. The connection elements 4 are here also inserted into a recess 9 on side walls 7, 8 of the lower container 2. The connection element 4 in this example is again comprised of a two-armed lever, which can be swiveled via bearing elements 37 about the rotary axis 14 in the direction of arrows 27. For resetting and securing in place of connection element 4, the spring element 25 is provided which is held in holding ribs 26 on container 2. On the first lever portion 11 of the connection element 4 is disposed the latching element 15 or the lobe 38. The second lever portion 12 with the latching element 15 in this case is directed upwardly. It is evident that in this embodiment the force flow is also conducted directly from the force absorption rib 21 via the support face 22 and the detent face 23 of lobe 38 to the holding rib 16. If the upper container 1 with the snapped-in connection elements 4 is lifted by the carrying handle 32 depicted in FIG. 1 together with the lower container 2, the force transfer occurs only via these elements and the connection element 4 itself is not placed under load. Consequently, the described advantages according to the invention are also obtained in this embodiment.

1 Connection system for stackable containers (1, 2) with connection elements (4), which automatically snap in and can be released again and which connect two containers (1, 2) abutting one another in the direction of the stack axis (3), wherein the connection elements (4) are connected with a first container (1) and include a resilient region with a latching element (15) and on the second container (2) holding ribs (16) are disposed for the cooperation with these latching elements (15), characterized in that the latching elements (15, 38, 39) have two force transfer faces (22, 23) on the connection elements (4), which are spaced apart in the direction of the stack axis (3) and which extend approximately parallel to one another as well as approximately at right angles to the axis (3) of containers (1, 2), on the first container (1) force absorption ribs (21) are disposed which cooperate with a first one of the force transfer faces in the form of a support face (22), on the second container (2) the holding ribs (16) are disposed which cooperate with a second one of the force transfer faces in the form of a detent face and herein, with the containers (1, 2) stacked with snapped-in connection elements (4), each of the force absorption ribs (21) on the first container (1) and their associated holding rib (16) on the second container (2) are directly connected with one another via the latching element (15, 38, 39) of a connection element (4) and form a direct chain of action for the force transfer between the containers (1, 2).

2. Connection system for stackable containers as claimed in patent claim 1, characterized in that bearing elements (37) form between the connection elements (4) and the container (1) a mechanical guidance without force transfer between containers (1, 2) and for this force transfer only the latching element (15, 38, 39) is implemented as well as the holding rib (16) and the force transfer rib (21).

3. Connection system for stackable containers as claimed in patent claim 1, characterized in that the holding ribs (16) on the second container (2) are disposed on a flange (19) of this second container (2), this flange (19) with the containers (2) stacked, overlaps a margin region (24) of the first container (1 and on this margin region (24) of the first container (1) the force absorption ribs (21) are disposed

4. Connection system for stackable containers as claimed in patent claim 1, characterized in that on the first container (1) at least one pair of connection elements (4) is disposed, wherein the two connection elements (4) of a pair are positioned on opposing side walls (5, 6) and on the second container (2) corresponding pairs of holding ribs (16) are disposed.

5. Connection system for stackable containers as claimed in patent claim 1, characterized in that between each connection element (4) and an adjacent wall (5, 6) of the first container (1) a spring element (25) is disposed, which presses the latching element (15, 38, 39) outwardly away from the outer surface (10) of the container wall (5, 6).

6. Connection system for stackable containers as claimed in patent claim 1, characterized in that each of the connection elements (4) is disposed in a recess (9) on the outer surface (10) of a side wall (5, 6) of the first container (1).

7. Connection system for stackable containers as claimed in patent claim 1, characterized in that two or more containers (1, 2) are connected with one another via connection elements (4).

8. Connection system for stackable containers as claimed in patent claim 1, characterized in that the latching element 15) is comprised of a lobe (38) on which the two force transfer faces (22, 23) are disposed.

9. Connection system for stackable containers as claimed in patent claim 1, characterized in that the latching element 15) is comprised of a C-shaped clasp (39) on which are disposed the two force transfer faces (22, 23).

10. Connection system for stackable containers as claimed in patent claim 1, characterized in that the connection element (4) is comprised of a lever and is swivellably supported via a bearing element (37) in the form of a pivot (14) on the first container (1), the latching element (15, 38, 39) being disposed on an outer swivellable end of this lever.

11. Connection system for stackable containers as claimed in patent claim 1, characterized in that the connection element (4) is comprised of a slide (40), wherein this slide (40) is supported on guidances (41) on the first container (1) and is displaceable approximately transversely to the stack axis (3) and the latching element (15, 38, 39) is disposed on a margin region (42) of this slide.

12. Connection system for stackable containers as claimed in patent claim 1, characterized in that the connection elements (4) and the force absorption ribs (21) are disposed in the bottom region (20) of side walls (5, 6) of the first container (1) and on the second container (2) are formed the holding ribs (16) on the upper margin (17).

13. Connection system for stackable containers as claimed in patent claim 1, characterized in that the connection elements (4) and the force absorption ribs (21) are disposed on the upper region of side walls (7, 8) of a container (2) and on the adjacent container (1) the holding ribs (16) are formed in the bottom region (20) of side walls (5, 6).

14. Connection system for stackable containers as claimed in patent claim 1, characterized in that the connection element (4) is formed as a two-armed lever and is supported via a bearing element (37) in the form of a pivot (14) on the first container (1), wherein on the first lever portion (11) the latching element (15, 38, 39) is formed and on the second lever portion (12) a grip element (13) is formed

15. Connection system for stackable containers as claimed in patent claim 1, characterized in that, with the containers (1, 2) stacked, between each force transfer rib (21) on the first container (1) and the associated holding rib (16) on the second container (2) in the direction of the stack axis (3) a clearance interspace is formed which corresponds to the distance between the force transfer faces in the form of the support face (22) and the detent face (23) on the latching element (15) in the form of a lobe (38).

16. Connection system for stackable containers as claimed in patent claim 1, characterized in that, with the containers (1 2) stacked, the force transfer rib (2) on the first container (1) and the associated holding rib (16) on the second container (2) are disposed such that they are directed toward one another and in the direction of the stack axis (3) are encompassed by the latching element 15) in the form of a C-shaped clasp (39).

17. Connection system for stackable containers as claimed in patent claim 9, characterized in that the C-shaped clasp (39) includes an opening (43), this opening (43) in the direction of the stack axis (3) is delimited by the support face (22) and the detent face (23) and the distance (44) between the support face (22) and the detent face (23) corresponds at least to the sum of the height of the holding rib (16) and of the height of the force absorption rib (21).
